(19) United States
(12) Patent Application Publication
(10) Pub. No.: US 2009/0097187 A1
(43) Pub. Date: Apr. 16, 2009

(54) MULTI-LAYER CERAMIC CAPACITOR WITH LOW SELF-INDUCTANCE

(75) Inventors: Sriram Dattaguru, Chandler, AZ (US); Haluk Balkan, Phoenix, AZ (US); Leigh Wojewoda, Tempe, AZ (US)

Correspondence Address: GROSSMAN, TUCKER, PERREAULT & PFLEGER, PLLC;c/o CPA Global, P. O. BOX 52050, MINNEAPOLIS, MN, 55402, US

(73) Assignee: INTEL CORPORATION, Santa Clara, CA (US)

(21) Appl. No.: 11/869,995

(22) Filed: Oct. 10, 2007

(51) Int. Cl. H01G 4/12; H01G 4/005

(52) U.S. Cl. 361/321.2; 361/303

(57) ABSTRACT

A Multi-layer Ceramic Capacitor (MLCC) device of a low self-inductance is disclosed. The MLCC device includes a plurality of ceramic sheets arranged in parallel to each other, a plurality of inner metal electrodes, and a plurality of outer electrodes including a pair of positive terminals and a pair of negative terminals. The plurality of inner metal electrodes and the plurality of ceramic sheets are stacked alternately to form a plurality of capacitors. The plurality of outer electrodes is disposed on corners of the plurality of ceramic sheets such that the pair of positive terminals is disposed on adjacent corners of the plurality of ceramic sheets and the pair of negative terminals is disposed on other set of adjacent corners of the plurality of ceramic sheets. An MLCC device having the plurality of outer electrodes disposed on middle portions of the edges of the plurality of ceramic sheets is also disclosed.

### FIELD

The present disclosure generally relates to integrated circuits, and, more particularly, to a Multi-Layer Ceramic Capacitor (MLCC) with low self-inductance.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1A is a diagram representing a three-dimensional (3D) view of a prior art MLCC device;

FIG. 1B is a diagram representing a planar view of the prior art MLCC device;

FIGS. 2A, 2B and 2C are diagrams representing 3D views of various known configurations of the prior art MLCC device;

FIG. 3 is a diagram representing a 3D view of an MLCC device, according to an exemplary embodiment of the present disclosure;

FIG. 4 is a diagram representing a 3D view of an MLCC device, according to another exemplary embodiment of the present disclosure; and

FIGS. 5A, 5B and 5C are diagrams representing internal diagrams of a prior art RGC MLCC device and the MLCC devices of FIGS. 3 and 4, according to an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference has to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

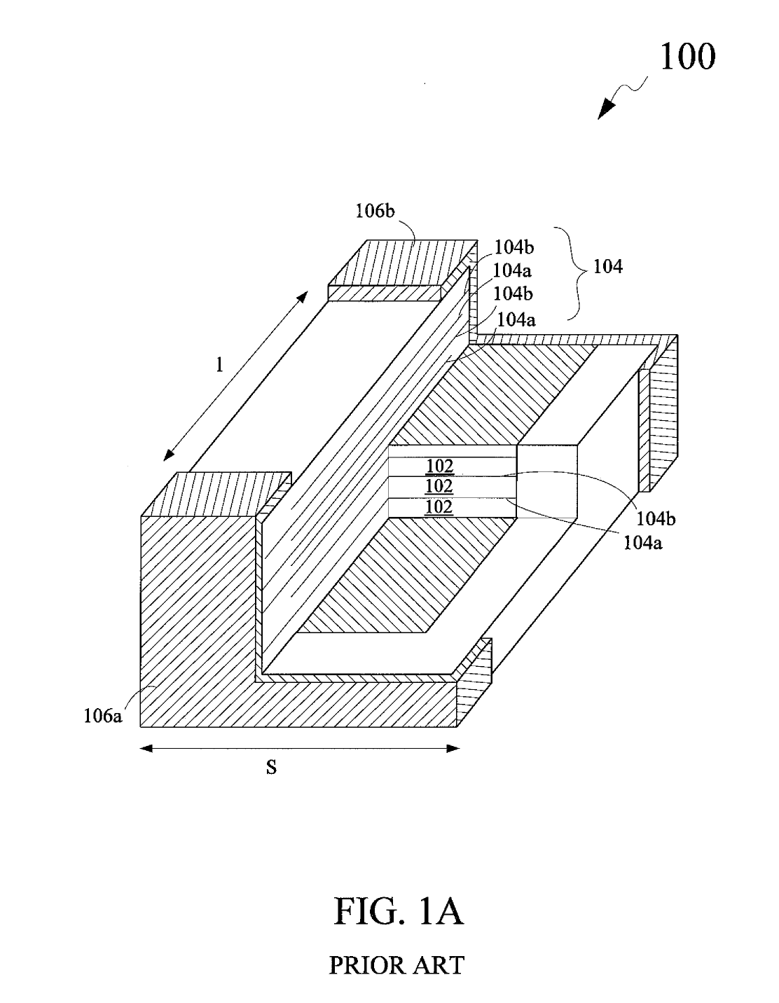

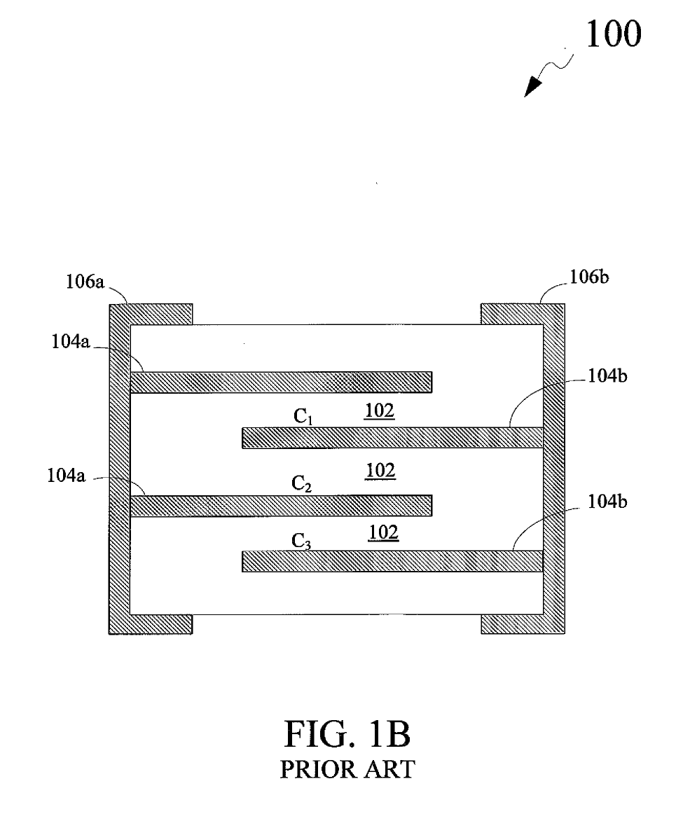

FIG. 1A is a diagram representing a 3D view of a prior art Multi-layer Ceramic Capacitor (MLCC) device 100 (hereinafter referred to as “device 100”). In general, an MLCC device is a special class of ceramic capacitor, which includes a plurality of capacitors stacked together in a device configuration in order to achieve a high volumetric efficiency, i.e. to achieve a high capacitance value per unit volume. The device 100 comprises a plurality of ceramic sheets 102 arranged parallel to each other, a plurality of inner metal electrodes 104 (hereinafter referred to as ‘electrodes 104’) and a plurality of outer electrodes such as an electrode 106a and an electrode 106b, which provide electrical connectivity to the device 100 in an electrical circuit. The electrodes 104 are stacked alternately with the plurality of ceramic sheets 102 to form a plurality of capacitors connected in parallel to each other.

The electrodes 104 comprise a first group of inner metal electrodes 104a (hereinafter referred to as ‘electrodes 104a’) and a second group of inner metal electrodes 104b (hereinafter referred to as ‘electrodes 104b’). The electrodes 104a and 104b are arranged alternately to each other. It will be apparent to a person skilled in the art that each capacitor of the plurality of capacitors is formed by an electrode 104a, an electrode 104b, and a ceramic sheet 102 sandwiched between the electrode 104a and the electrode 104b. The electrode 104a and the electrode 104b act as two plates of the capacitor and the ceramic sheet 102 acts as a dielectric of the capacitor. The electrodes 104a are connected to the outer electrode 106a and the electrodes 104b are connected to the outer electrode 106b.

FIG. 1B is a diagram representing a planar view of the device 100. As shown in FIG. 1B, the device 100 comprises a plurality of capacitors C1, C2 and C3 arranged in parallel. Each of the capacitors C1, C2 and C3 is formed between an electrode 104a of the electrodes 104a and an electrode 104b of the electrodes 104b and a ceramic sheet 102 sandwiched between the electrodes 104a and 104b. It is also evident from the FIG. 1B that the electrodes 104a are connected to the outer electrode 106a and the electrodes 104b are connected to the outer electrode 106b. From manufacturing point of view of the device 100, an electrode of the electrodes 104 is printed on the ceramic sheet 102 by applying a conventional screen-printing method. A number of such ceramic sheets 102 are stacked and pressed together to form a laminated structure. Further, the outer electrodes 106a and 106b are connected to the stacked sheets, thereby forming the device 100.

The device 100 is advantageous in designing modern day electrical and electronic devices, as the device 100 consumes less space due to high volumetric efficiency. However, a common drawback with the use of the device 100 in the electrical and electronic devices is a high self-inductance of the device 100. Circuits of such electrical and electronic devices operate at very high switching speeds and high self-inductance values that may cause unacceptable voltage spikes (V=L*di/dt, where L is the self-inductance of the device 100 and the V is a value of the voltage spike). Therefore, for the circuits operating at high switching speeds, the voltage spikes may be reduced by reducing the self-inductance of the device 100. It is known that the self-inductance of the device 100 may be controlled by controlling certain parameters of the device 100 such as a length of path between the outer electrodes of opposite polarities, which is also known as current path length (shown in FIG. 1A as ‘l’ and hereinafter referred to as ‘length l’), a width of the outer electrode known as span length (shown in FIG. 1A as ‘s’ and hereinafter referred to as ‘length s’) of the device 100.

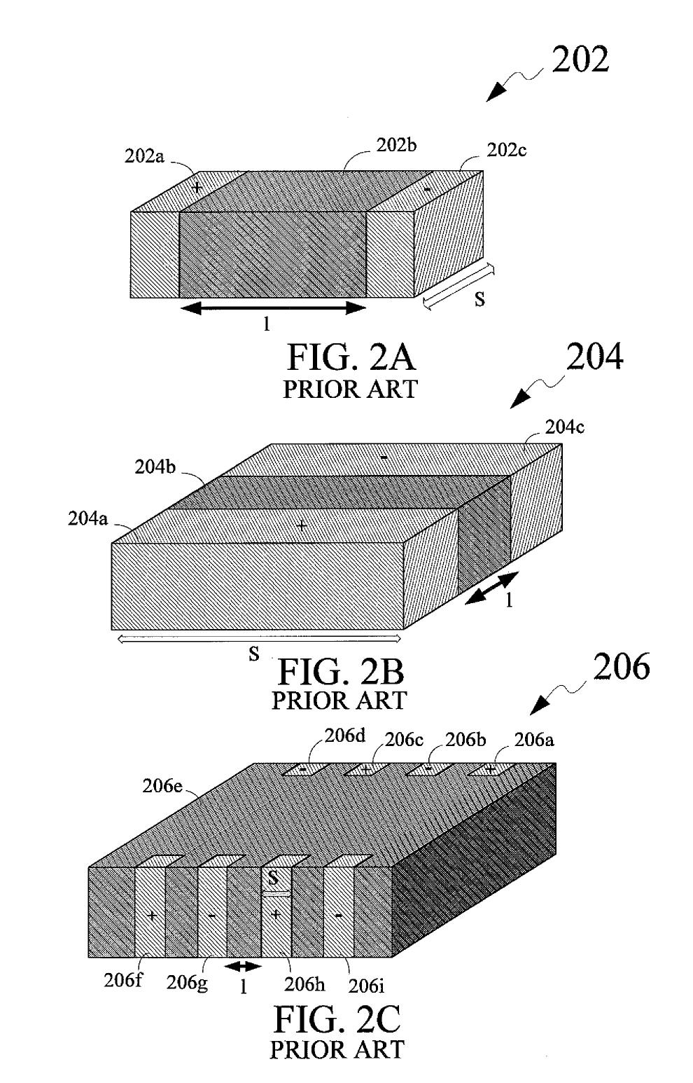

Also, the self-inductance of the device 100 may be controlled by introducing opposing current loops in the device 100 in order to cancel the effects of induction caused by a current loop with that of a corresponding opposing current loop. It may be further noted that a reduction in ‘length l’ and an increase in the ‘length s’ reduces the self-inductance of the device 100. A number of configurations of the device 100 are known, which control one or more of the aforementioned parameters to reduce the self-inductance. Some of the known configurations are described in conjunction with FIGS. 2A, 2B and 2C.

FIGS. 2A, 2B and 2C are diagrams representing 3D view of various known configurations of the device 100. FIG. 2A illustrates a MLCC device 202 of standard configuration (hereinafter referred to as ‘device 202’) comprising a pair of outer electrodes 202a and 202c and an internal structure 202b. The internal structure 202b comprises a plurality of ceramic sheets (not shown) and a plurality of inner metal electrodes (not shown) stacked alternately with the plurality of ceramic sheets to form a plurality of capacitors (not shown). The arrangement of the plurality of ceramic sheets and the plurality of inner metal electrodes in the device 202 is similar to the arrangement of the ceramic sheets 102 and the electrodes 104 as described in conjunction with FIGS. 1A and 1B. The internal structure 202b is sandwiched between the outer electrodes 202a and 202c. It is evident that a larger value of a ‘length l’ of the device 202 as compared to a ‘length s’ of the device 202 results in a high self-inductance of the device 202.

FIG. 2B illustrates a MLCC device 204 of Reverse Geometry Capacitor (RGC) configuration (hereinafter referred to as “device 204”). The device 204 comprises outer electrodes 204a and 204c, which are disposed along longer edges of the device 204. The device 204 further comprises an internal structure 204b, which has a plurality of ceramic sheets (not shown) and a plurality of inner metal electrodes (not shown) stacked alternately with the plurality of ceramic sheets to form a plurality of capacitors (not shown). The internal structure 204b is sandwiched between the outer electrodes 204a and 204c. As the outer electrodes 204a and 204c are disposed along the longer dimension of the device 204, the ‘length l’ of the device 204 is less than the ‘length l’ of the device 202. A lower value of the ‘length l’ of the device 204 results in a lower self-inductance value for the device 204 as compared to the device 202.

FIG. 2C illustrates an exemplary MLCC device 206 of an Inter-Digitated Capacitor (IDC) configuration (hereinafter referred to as “device 206”). The IDC configuration introduces opposing current loops in the device 206 in order to mutually cancel the self-inductance caused by each of the current loops. The device 206 comprises eight outer electrodes 206a, 206b, 206c, 206d, 206f, 206g, 206h and 206i and an internal structure 206e. The internal structure 206e comprises a plurality of ceramic sheets (not shown), and a plurality of inner metal electrodes (not shown) stacked alternately with the plurality of ceramic sheets to form a plurality of capacitors. The internal structure 206e is sandwiched between the outer electrodes 206a, 206c, 206f, 206h and 206b, 206d, 206g, 206i. The outer electrodes 206a, 206c, 206f and 206h are connected to positive polarity while the outer electrodes 206b, 206d, 206g and 206i are connected to negative polarity. The outer electrodes may be grouped in pairs to form opposing current loops. For example, outer electrode 206a and 206b form a first current loop and outer electrodes 206h and 206i form a second current loop.

The first current loop and the second current loop are opposing each other due to their opposite polarity. Therefore, the self-inductance due to the first loop cancels out the effect of the self-inductance due to second loop. The device 206 has a least self-inductance as compared to the previously described configurations of the device 100. However, the configuration of device 206 and 207 is not suitable for fabricating a MLCC device with a small form-factor. Accommodating multiple outer electrodes within reduced dimensions of the small form-factor MLCC device may be ineffective in terms of ease of manufacture and cost of production. Accordingly, there arises a need for a MLCC device which has a low self-inductance and which is capable of being fabricated in a small form-factor.

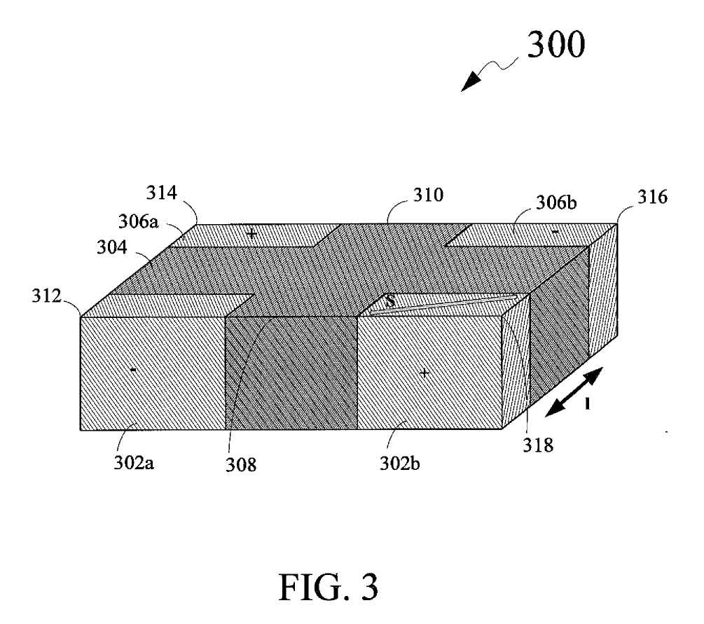

The present disclosure provides a MLCC device having a small form-factor and a low self-inductance. FIG. 3 is a diagram representing a 3D view of a MLCC device 300 of a “Four-Sided Corner Termination (FSCT)” configuration (hereinafter referred to as “device 300”), according to an embodiment of the present disclosure. It may be pointed out that internal structure 304 of the device 300 is similar to that of the device 100. The device 300 is, however, improved over the device 100 in terms of configuration of outer electrodes.

FIG. 3 describes a small form-factor device 300, where the inherent problem of self-inductance has been reduced by controlling the ‘length l’ and the ‘length s’ in the device 300. The device 300 comprises a plurality of ceramic sheets (not shown), a plurality of inner metal electrodes (not shown) and four outer electrodes 302a, 302b, 306a and 306b arranged on each corner of the plurality of ceramic sheets of the device 300. It may be noted that in view of the typical placement of the outer electrodes 302a, 302b, 306a and 306b on the four corners of the plurality of ceramic sheets of the device 300, the device 300 may be referred to as the “Four-Sided Corner Termination (FSCT)” configuration. The plurality of ceramic sheets and the plurality of inner metal electrodes have been represented as the structure 304 in the device 300.

The arrangement of the plurality of ceramic sheets of the structure 304 is similar to ceramic sheets 102 of device 100. Further, the plurality of inner metal electrodes of the structure 304 is also arranged similar to the electrodes 104 of device 100. The plurality of inner metal electrodes may be grouped in a first group of inner metal electrodes (not shown) and a second group of inner metal electrodes (not shown). The arrangement of the first group of inner metal electrodes and the second group of inner metal electrodes may be explained by referring FIG. 1A. For example, the electrodes 104a may represent the first group of the inner metal electrodes and the electrodes 104b may represent the second group of inner metal electrodes.

The device 300 illustrates an exemplary embodiment of the present disclosure, where the outer electrodes 302a, 306b are provided with a positive polarity (hereinafter collectively termed as ‘a pair of positive terminals’) and the outer electrodes 306a, 302b are provided with a negative polarity (hereinafter collectively termed as ‘a pair of negative terminals’). Further, in the said embodiment of the present disclosure, the first group of inner metal electrodes is connected to the pair of positive terminals 302a, 306b and the second group of inner metal electrodes is connected to the pair of negative terminals 306a, 302b. The pair of positive terminals 302a and 306b is disposed on a set of adjacent corners 312 and 316 which lie along the diagonal 308 of the device 300. Also, the pair of negative terminals 306a and 302b is disposed on another set of adjacent corners 314 and 318 which lie along another diagonal 310 of the device 300. It is obvious to a person skilled in the art that the outer electrodes 302a, 306b and 306a, 302b may alternatively be provided with the negative polarity and positive polarity respectively.

As a result of disposing the outer electrodes on the corners of the device 300, the ‘length l’ in the device 300 is controlled. It is evident that the ‘length l’ in the device 300 is less as compared to the device 202 (standard configuration) and the device 204 (RGC configuration) as the outer electrodes of the device 300 having opposite polarity, such as the electrode 302a and 306a, are disposed at the corners of a shorter edge of the device 300. Therefore, the self-inductance of the device 300 would be less than that of the devices 202 and 204. It may also be evident to a person skilled in the art that the ‘length s’ of each of the outer electrodes 302a, 302b, 306a and 306b may be controlled to further limit the self-inductance of the device 300.

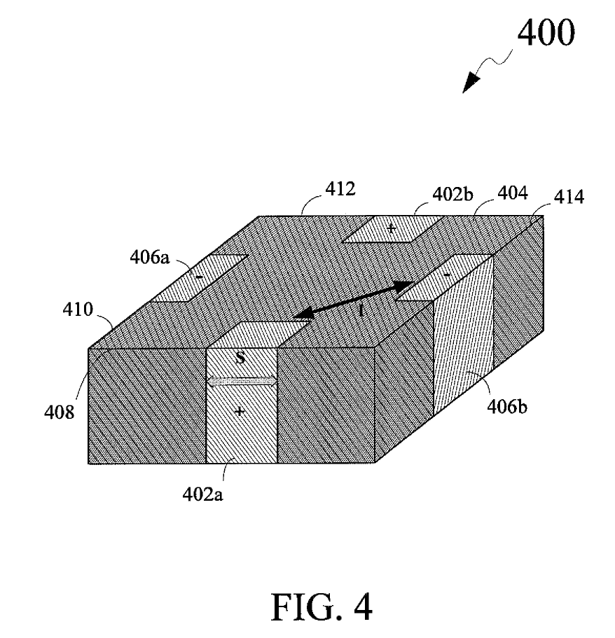

FIG. 4 is a diagram representing a 3D view of a MLCC device 400 of a “Four-Sided Stripe Termination (FSST)” configuration (hereinafter referred to as “device 400”), according to another exemplary embodiment of the present disclosure. The device 400 comprises a plurality of ceramic sheets (not shown), a plurality of inner metal electrodes (not shown) and four outer electrodes 402a, 402b, 406a and 406b disposed on middle portions of edges of the plurality of ceramic sheets of the device 400. The plurality of ceramic sheets and the plurality of inner metal electrodes are represented as a structure 404 in the device 400.

The arrangement of the plurality of ceramic sheets of the structure 404 is similar to the ceramic sheets 102 of the device 100. Further, the plurality of inner metal electrodes of the structure 404 is also arranged similar to the electrodes 104 of the device 100. The plurality of ceramic sheets may be stacked alternately with the plurality of inner metal electrodes to form a plurality of capacitors connected in parallel to each other. The plurality of inner metal electrodes may be grouped in a first group of the inner metal electrodes (not shown) and a second group of inner metal electrodes (not shown). The arrangement of the first group and the second group of the inner metal electrodes may be explained by referring to FIG. 1A. For example, the electrodes 104a may represent the first group of the inner metal electrodes and the electrodes 104b may represent the second group of inner metal electrodes.

The outer electrodes 402a, 402b are disposed on a set of opposite edges 408 and 412 respectively of the device 400 while the outer electrodes 406a, 406b are disposed on another set of opposite edges 410 and 414 respectively of the device 400. In an exemplary embodiment, the outer electrodes 402a, 402b of the device 400 are provided a positive polarity and the outer electrodes 406a, 406b of the device 400 are provided a negative polarity. The outer electrodes 402a and 402b may be referred to as ‘a pair of positive terminals’ and the outer electrodes 406a and 406b may be referred to as a ‘pair of negative terminals’. Further, in the described embodiment of the present disclosure, the first group of inner metal electrodes of the device 400 may be connected to the pair of positive terminals and the second group of inner metal electrodes of the device 400 may be connected to the pair of negative terminals. In another exemplary embodiment of the present disclosure, the outer electrodes 402a, 402b may be provided the negative polarity and the outer electrodes 406a, 406b may be provided the positive polarity.

As a result of the polarities supplied to the outer electrodes 402a, 402b, 406a and 406b, two current loops are formed in the device 400 by grouping a set of positive terminal and a negative terminal together. In an exemplary embodiment of the present disclosure, the outer electrodes 402a and 406b form a first current loop and the outer electrodes 402b and 406a form a second current loop. In another exemplary embodiment of the present disclosure, the outer electrodes 402a and 406a may form the first current loop and the outer electrodes 402b and 406b may form the second current loop. It is evident that the first and the second current loop would oppose the effect of each other on account of opposite polarities of the two current loops. The presence of two opposing current loops in the device 400 helps to reduce the self-inductance of the device 400.

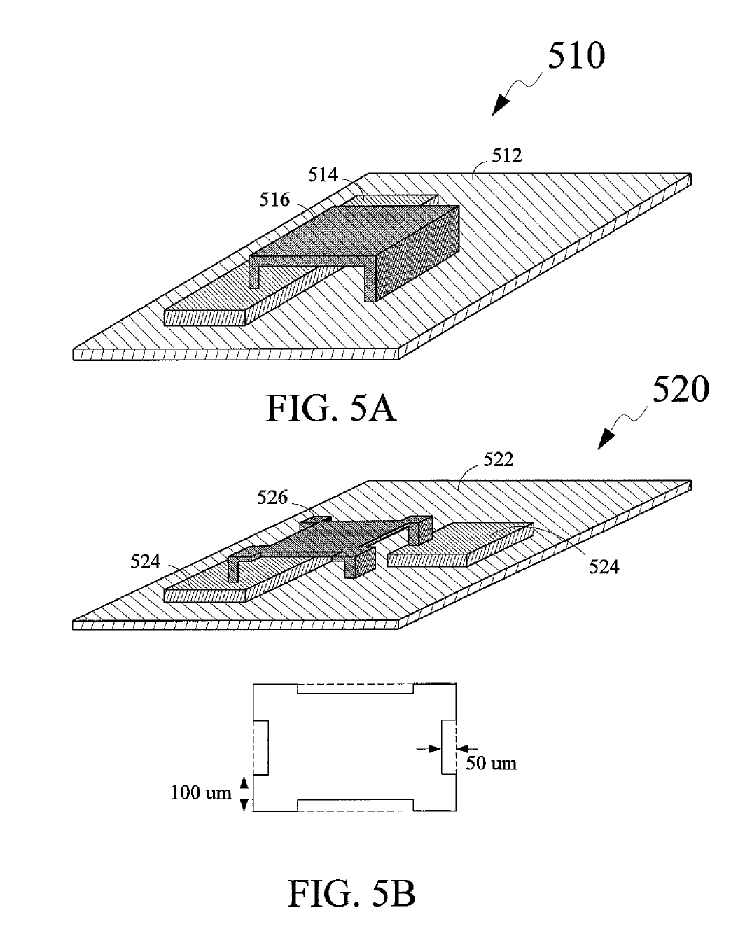

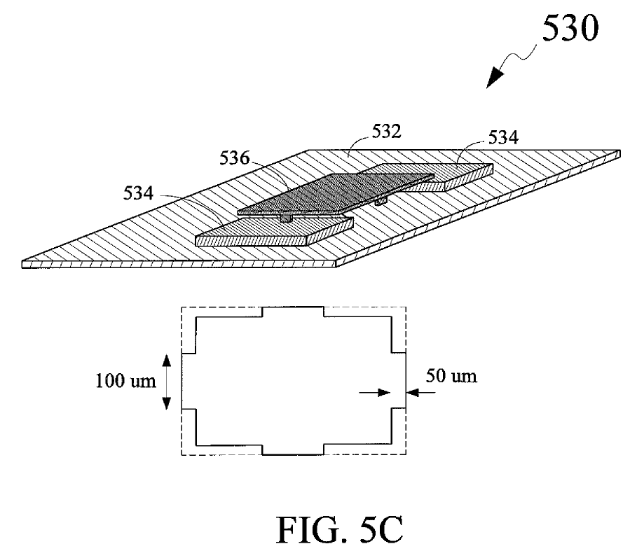

FIGS. 5A, 5B and 5C are diagrams representing internal diagrams of the device 204, the device 300 and the device 400 respectively. These internal diagrams are an exemplary representation and are simulation specific models with an assumption that the devices 204, 300 and 400 have the same form-factor. For example, let the form-factor of each of the devices 204, 300 and 400 be 0204. With the help of a simulation specific model, a value of self-inductances for each of the devices 204, 300 and 400 may be estimated. The following sections describe the simulation specific models and the estimated value of self-inductances for each of the simulation specific models.

FIG. 5A illustrates a simulation model 510 for the device 204. The model 510 illustrates a ceramic sheet 512 with an inner metal electrode 514 screen-printed on the ceramic sheet 512. The model 510 also illustrates an outer electrode 516 connected to the inner metal electrode 514. The simulation model 520 assumes the ‘length s’ equal to 100 um. An estimated value of the self-inductance of the simulation model 510 is about 124 pH.

Further, FIG. 5B illustrates a simulation model 520 for the device 300. The model 520 illustrates a ceramic sheet 522 with an inner metal electrode 524 screen-printed on the ceramic sheet 522. The model 520 also illustrates an outer electrode 526 connected to the inner metal electrode 524. The simulation model 520 assumes the ‘length s’ equal to 100 um. It is observed that the estimated value of the self-inductance of the simulation model 520 is 124 pH.

Furthermore, FIG. 5C illustrates a simulation model 530 for the device 400. The simulation model 530 illustrates a ceramic sheet 532 with an inner metal electrode 534 screen-printed on the ceramic sheet 532. The model 530 also illustrates an outer electrode 536 connected to the inner metal electrode 534. The model 530 also assumes a ‘length s’ equal to 100 um. It is further observed that an estimated value for self-inductance of the simulation model 530 is about 110 pH.

It may be observed from the simulation models that the device 300 has a self-inductance equivalent to that of the device 204, i.e. the FSCT configuration and the RGC configuration have a comparable value for self-inductance. It may also be observed that device 400 has a lower self-inductance than both the device 204 and the device 300. Therefore, it may be deduced that the FSST configuration has the least self-inductance amongst all other configurations with the same form-factor. Although the simulation models 510, 520 and 530 assume the ‘length s’ to be 100 um, the ‘length s’ may be practically increased by up to 1.5 times along a shorter edge of a MLCC device and by up to 2 to 4 times along a longer edge of the MLCC device. Therefore, with an increase in the ‘length s’, as envisaged above, the self-inductance of the MLCC device would further be reduced.

In another exemplary embodiment of the present disclosure, the form-factor of the devices is assumed to be 0402. Table 1 below represents a comparative analysis of self-inductances of the different devices on 0402 form factor.

TABLE 1

| Design | Self-inductance (in pH) |
|---|---|
| Standard 2T | 265 |
| RGC | 124 |
| IDC(4T) | 110 |
| FSCT | 124 |
| FSST | 104 |

The first entry in Table 1 relates to the standard configuration, with 2 terminals, of the device 202 defined in conjunctions with FIG. 2A. The table illustrates the measured value of self-inductance for a standard 2T configuration as 265 pH. Similarly the table further illustrates the self-inductance for an RGC configuration of the device 204 as equal to 124 pH and the self-inductance of a four-terminal IDC configuration of the device 206 as equal to 110 pH. The remaining entries in Table 1 relate to the device 300, i.e. the FSCT configuration, and the device 400, i.e. the FSST configuration. It may be observed that the FSCT configuration has a self-inductance of 124 pH and the FSST configuration has a self-inductance of 104 pH. It is evident from the table that the device 400 of FSST configuration has a lowest value of self-inductance as compared to all the known configurations of the device 100. Also, the self-inductance for the device 300 of FSCT configuration is comparable to the RGC configuration of the device 100.

Various embodiments of the present disclosure offer following advantages. The present disclosure provides low value of self-inductance in the FSCT and FSST configurations. The FSCT and the FSST configurations are easier to design and do not require extreme design control. The FSCT design is easier as the corners of the MLCC can be applied with a termination paste to achieve a good termination of the outer electrodes at the corners. Further, in case of the FSST design, termination process is easier as a pitch is not critical. Further, the present disclosure provides an option of reducing the form factor specifications of a MLCC device while maintaining a low self-inductance.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A Multi-Layer Ceramic Capacitor (MLCC) device, comprising:
a plurality of ceramic sheets arranged parallel to each other;
a plurality of inner metal electrodes stacked alternately with the plurality of ceramic sheets to form a plurality of capacitors, the plurality of inner metal electrodes grouped in a first group of inner metal electrodes and a second group of inner metal electrodes, wherein the first group of the inner metal electrodes and the second group of inner metal electrodes are arranged alternately; and
a plurality of outer electrodes, the plurality of outer electrodes comprising a pair of positive terminals and a pair of negative terminals;
wherein the first group of inner metal electrodes is connected to the pair of positive terminals of the plurality of outer electrodes and the second group of inner metal electrodes is connected to the pair of negative terminals of the plurality of outer electrodes; and
wherein the pair of positive terminals is disposed on a first set of diagonal corners of the plurality of ceramic sheets and the pair of negative terminals is disposed on a second set of diagonal corners of the plurality of ceramic sheets.

2. The MLCC device of claim 1, wherein the first set of diagonal corners is of a longer edge of the plurality of ceramic sheets, and wherein the second set of adjacent corners is of another longer edge of the plurality of ceramic sheets.

3. The MLCC device of claim 1, wherein the length between a positive terminal outer electrode and a negative terminal outer electrode is controlled by the length of said outer electrodes.

4. A Multi-Layer Ceramic Capacitor (MLCC) device, comprising:
a plurality of ceramic sheets arranged parallel to each other;
a plurality of inner metal electrodes stacked alternately with the plurality of ceramic sheets to form a plurality of capacitors, the plurality of inner metal electrodes grouped in a first group of inner metal electrodes and a second group of inner metal electrodes, wherein the first group of the inner metal electrodes and the second group of inner metal electrodes are arranged alternately; and
a plurality of outer electrodes, the plurality of outer electrodes comprising a pair of positive terminals and a pair of negative terminals;
wherein the first group of inner metal electrodes is connected to the pair of positive terminals of the plurality of outer electrodes and the second group of inner metal electrodes is connected to the pair of negative terminals of the plurality of outer electrodes; and
wherein the pair of positive terminals is disposed on middle portions of a set of opposite edges of the plurality of ceramic sheets and the pair of negative terminals is disposed on middle portions of another set of opposite edges of the plurality of ceramic sheets.

5. The MLCC device of claim 4, wherein the first set of diagonal corners is of a longer edge of the plurality of ceramic sheets, and wherein the second set of adjacent corners is of another longer edge of the plurality of ceramic sheets.

6. The MLCC device of claim 4, wherein the length between a positive terminal outer electrode and a negative terminal outer electrode is controlled by the length of said outer electrodes.
